(19) United States
(12) Patent Application Publication
(10) Pub. No.: US 2015/0207948 A1
(43) Pub. Date: Jul. 23, 2015

(54) IMAGE PROCESSING APPARATUS, NON-TRANSITORY COMPUTER READABLE MEDIUM, AND IMAGE PROCESSING METHOD

(71) Applicant: FUJI XEROX CO., LTD, Tokyo (JP)

(72) Inventor: Masayuki YAMAGUCHI, Kanagawa (JP)

(73) Assignee: FUJI XEROX CO., LTD, Tokyo (JP)

(21) Appl. No.: 14/480,043

(22) Filed: Sep. 8, 2014

(30) Foreign Application Priority Data
Jan. 20, 2014 (JP) 2014-007613

(51) Int. Cl. H04N 1/00; H04N 1/387

(52) U.S. Cl. CPC H04N 1/00774; H04N 1/00689; H04N 1/00692; H04N 1/00724; H04N 1/00734; H04N 1/00769; H04N 1/387; H04N 1/00766; H04N 1/00771

(57) ABSTRACT

An image processing apparatus includes a detector that detects the presence or absence of a sticky note stuck on an original on the basis of first image data, the first image data being generated by reading an image of the original, and an executing unit that executes processing related to correction of the original, in a case where the sticky note is detected by the detector.

### CROSS-REFERENCE TO RELATED APPLICATIONS

This application is based on and claims priority under 35 USC 119 from Japanese Patent Application No. 2014-007613 filed Jan. 20, 2014.

### BACKGROUND

(i) Technical Field

The present invention relates to an image processing apparatus, a non-transitory computer readable medium, and an image processing method.

(ii) Related Art

Systems exist which convert a document in paper form into electronic data for viewing on a personal computer or the like. For example, these systems generate electronic image data by reading a document in paper form by an image reading device such as a scanner. By converting a document in paper form into electronic form in this way, a system that offers excellent shareability, portability, and ease of search is built, thereby improving user convenience.

In the medical field, electronic data such as an electronic medical chart is used in some cases to share information between distant facilities or within related business categories (for example, hospitals, clinics, dispensing pharmacies, home-visit nursing stations, and caregiving and welfare service facilities). However, electronic mechanical charts are sometimes not adopted in relatively small hospitals or clinics. Even in medical institutions that adopt electronic medical charts, not all information is documented in electronic form but information highly necessary for medical care is exchanged in the form of paper documents. Further, there are also needs for using medical charts or the like as they are in their paper form. As described above, in a case where a document in paper form is used, in order to share information, it is necessary to send the document in paper form to the other party by faxing or copying, which is troublesome. Accordingly, in some cases, information sharing is accomplished by, for example, reading the image of an original in paper form (hereinafter abbreviated as “paper original”) such as a medical chart to convert the paper original into electronic form, and storing the image data converted into electronic form into a shared server or the like. At this time, in some cases, information other than medical charts (for example, examination information, nursing records, caregiving notes, and prescribed medicine information) is also converted into electronic form and stored into a shared server or the like to share information. Image data converted into electronic form in this way is stored into the shared server or the like in association with the paper original.

In the case of a system that manages information by using the paper original and its image data as described above, when an erroneous entry, an omission, or the like in the paper original is discovered, and it becomes necessary to correct the contents of the paper original, in some cases, the contents of the paper original are corrected, and the corrected paper original is converted into electronic form, thereby replacing (updating) the image data of the paper original. That is, when the contents of the paper original are corrected, conversion of the paper original into electronic form (hereinafter also referred to as “digitization”) is performed again in some cases. For example, the need for correcting the paper original is determined by periodically auditing/checking (for example, checking for alterations, or erroneous entries or omissions in required items) a medical chart or the like by a person who has the authority to audit/check the medical chart or the like, such as a health information manager. However, even when the need for correcting the paper original arises, a person who does not have the authority to correct the paper original is sometimes prohibited from directly writing in the paper original. In such cases, the person without the authority to make corrections writes down what correction is to be made or what part of the paper original is to be corrected on a sticky note or the like, sticks the sticky note onto the paper original, and requests a person having the authority to make corrections such as a doctor to make the indicated correction. Then, when the contents of the paper original are corrected by the person having the authority to make corrections, digitization of the corrected paper original is performed to generate image data on which the correction has been reflected, thereby updating the image data of the paper original. As described above, re-digitization of the paper original does not take place until a person having the authority to make corrections corrects the contents of the paper original. Consequently, even when it is found that there is a defect in the contents of the paper original, indication or correction of the defect is not reflected on the image data until re-digitization of the paper original is performed. Therefore, even when a third person views the image data, the third person may not become aware of the defect present in the contents of the paper original, with the result the image data in which the defect remains is downloaded or distributed as it is.

### SUMMARY

According to an aspect of the invention, there is provided an image processing apparatus including a detector that detects presence or absence of a sticky note stuck on an original on a basis of first image data, the first image data being generated by reading an image of the original, and an executing unit that executes processing related to correction of the original, in a case where the sticky note is detected by the detector.

### BRIEF DESCRIPTION OF THE DRAWINGS

Exemplary embodiments of the present invention will be described in detail based on the following figures, wherein:

FIG. 1 is a block diagram illustrating an example of an image processing apparatus according to exemplary embodiments of the invention;

FIG. 2 is a schematic illustration of an example of a paper original and image data;

FIG. 3 is a schematic illustration for explaining difference processing, illustrating an example of image data;

FIG. 4 illustrates an example of a table used for managing the status of the paper original;

FIG. 5 illustrates an example of an e-mail indicating a request for correcting the paper original;

FIG. 6 illustrates an example of an e-mail indicating completion of correction;

FIG. 7 illustrates an example of a screen for specifying an operation mode;

FIG. 8 illustrates the flow of processing according to Comparative Example 1; and

FIG. 9 illustrates the flow of processing according to Comparative Example 2.

### DETAILED DESCRIPTION

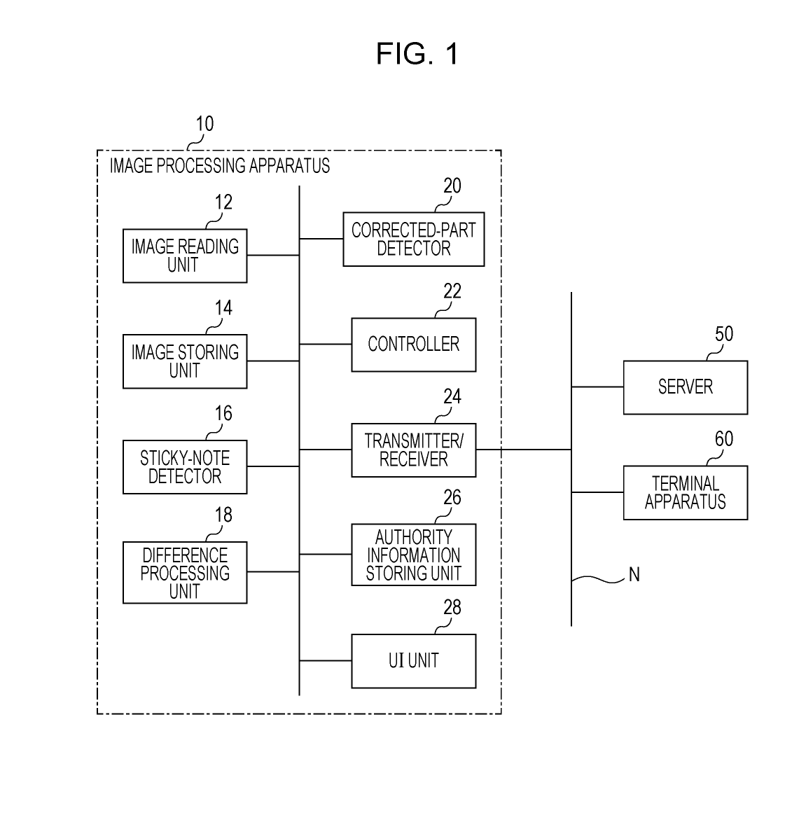

FIG. 1 illustrates an example of an image processing apparatus according to exemplary embodiments of the invention. An image processing apparatus 10 according to the exemplary embodiments includes an image reading unit 12, an image storing unit 14, a sticky-note detector 16, a difference processing unit 18, a corrected-part detector 20, a controller 22, a transmitter/receiver 24, an authority information storing unit 26, and a user interface (UI) unit 28. Further, the image processing apparatus 10 is connected to a communication path N such as a network. For example, a server 50 or a terminal apparatus 60 are connected to the communication path N. The server 50 is, for example, a shared server. The terminal apparatus 60 is, for example, a personal computer, a smart phone, a tablet terminal, or a cellular phone. The image processing apparatus 10, the server 50, and the terminal apparatus 60 may transmit or receive various data to and from one another via the network N.

The image reading unit 12 is an image reading device such as a scanner or a digital camera. The image reading unit 12 generates electronic image data by reading an image on a sheet of paper (paper original). The image storing unit 14 stores image data generated by the image reading unit 12. The image data generated by the image reading unit 12 may be transmitted to the server 50 and stored into the server 50.

The sticky-note detector 16 detects the presence or absence of a sticky note stuck on a paper original, on the basis of image data representing the paper original. That is, the sticky-note detector 16 detects the presence of absence of a sticky note represented in the image data. For example, the characteristic features of a sticky note (for example, the shape, size, and color of the sticky note) are previously set in the sticky-note detector 16, and the sticky-note detector 16 detects a region in image data which matches the previously set characteristic features as a region of one sticky note. In a case where multiple sticky notes are stuck on a paper original, the sticky-note detector 16 detects the multiple sticky notes. In the exemplary embodiments, the sticky-note detector 16 detects the presence or absence of a “correction-indicating note” that is stuck on the paper original as a sticky note.

The difference processing unit 18 detects the difference between two pieces of image data to generate difference image data representing the difference. For example, the difference processing unit 18 detects the difference between image data representing a paper original on which a sticky note is not stuck, and image data representing a paper original on which a sticky note is stuck to thereby generate difference image data representing the sticky note (hereinafter referred to as “sticky-note image data”).

The corrected-part detector 20 detects a corrected part of a paper original on the basis of image data representing the paper original. For example, the corrected-part detector 20 detects the difference between image data representing a paper original that has been already corrected, and image data representing a paper original that has not been corrected yet, and detects a part where a difference occurs between the two pieces of image data, other than the part of the sticky note, as a corrected part.

The controller 22 controls various units of the image processing apparatus 10. For example, the controller 22 switches operation modes related to image reading, manages image data, and controls transmission of various data.

The transmitter/receiver 24 is, for example, a network interface, which transmits and receives data via the network N. For example, the transmitter/receiver 24 transmits image data to the server 50 or the terminal apparatus 60, or receives image data from the server 50 or the terminal apparatus 60.

The authority information storing unit 26 stores viewing authority information indicating the authority of individual users with respect to viewing of image data, and correction authority information indicating the authority of individual users with respect to correction of the paper original.

The UI unit 28 includes an operating unit and a display. In the UI unit 28, an instruction from the user is accepted by the operating unit, and various types of information are displayed on the display.

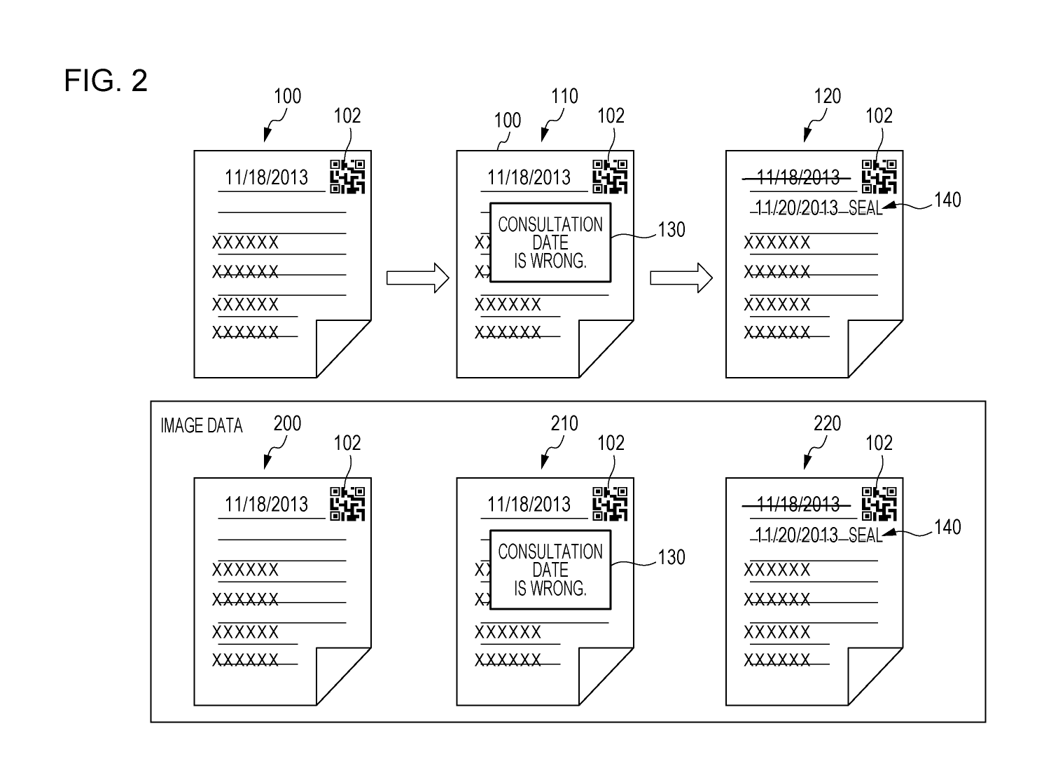

Now, referring to FIG. 2, an example of a paper original handled in the exemplary embodiments, and an example of an implementation using the paper original will be described. A paper original 100 illustrated in FIG. 2 is, for example, a medical chart (hereinafter referred to simply as “chart”) in paper form or a medical questionnaire (hereinafter referred to simply as “questionnaire”) in paper form used in medical institutions such as hospitals. The following pieces of information are coded in the manner of a two-dimensional barcode 102 or the like and printed on the paper original 100 in advance: type identification information for identifying the type (type such as chart, questionnaire, or the like) of the paper original 100; page information indicative of page number of the paper original 100; information indicative of patient name; patient ID; information indicative of clinical department name; information indicative of consultation date; information indicative of the storage location of image data generated by digitization of the paper original 100; and the file name or the like of the above-mentioned electronic data.

With regard to charts or questionnaires, in some cases, an implementation is made which permits a specific person to make entries or corrections in these documents. For example, the authority to makes entries in a chart or questionnaire, and the authority to correct its contents are limited to a doctor, and persons other than the doctor are prohibited from making entries and corrections. More specifically, in some cases, a doctor who has conducted the consultation has the authority to make entries or corrections in the chart or questionnaire, and persons other than the doctor are prohibited from making entries or corrections.

When a medical consultation or the like is conducted, a doctor who has the authority to make entries, for example, a doctor who has conducted the consultation enters information such as the consultation date and examination records into the paper original 100. The paper original 100 with information such as the consultation date and examination records entered is periodically audited/checked by a person having the authority to audit/check charts or questionnaires, such as a health information manager. In a case where an erroneous entry, an omission, or the like in a required item is discovered, as illustrated in FIG. 2, the health information manager or the like writes down what correction is to be made or the part to be corrected on a sticky note, and sticks the sticky note (a correction-indicating note 130 describing what correction is to be made and what part of the paper original is to be corrected) onto the paper original 100. For example, the health information manager or the like sticks the correction-indicating note 130 onto the paper original 100 with such an adhesion strength that allows the correction-indicating note 130 to be peeled off from the paper original 100 later. In a paper original 110 that is to be corrected later (hereinafter referred to as “to-be-corrected paper original 110”) which is illustrated in FIG. 2, the correction-indicating note 130 is stuck on the paper original 100. For example, in a case where there is a mistake in the consultation date entered in the paper original 100, a message such as “The consultation date is wrong.” is written in the correction-indicating note 130.

The to-be-corrected paper original 110 is passed to a doctor having the authority to make corrections, and the contents of the paper original 100 are corrected under the authority of the doctor. In a paper original 120 that has been already corrected (hereinafter referred to as “already-corrected paper original 120”) which is illustrated in FIG. 2, the consultation date is corrected as indicated by a corrected part 140. For example, a horizontal line indicating a correction is drawn over a character string indicating the originally entered consultation date (Nov. 18, 2013), and the correct consultation date (Nov. 20, 2013) is written below the corrected character string. Further, a correction seal is stamped to indicate that the correction has been already made.

When the image of the paper original 100 is read by the image reading unit 12, as illustrated in FIG. 2, image data 200 representing the paper original 100 is generated. When the image of the to-be-corrected paper original 110 is read by the image reading unit 12, image data 210 representing the paper original 100 on which the correction-indicating note 130 is stuck is generated. When the image of the already-corrected paper original 120 is read by the image reading unit 12, image data 220 representing the paper original on which a correction has been reflected is generated.

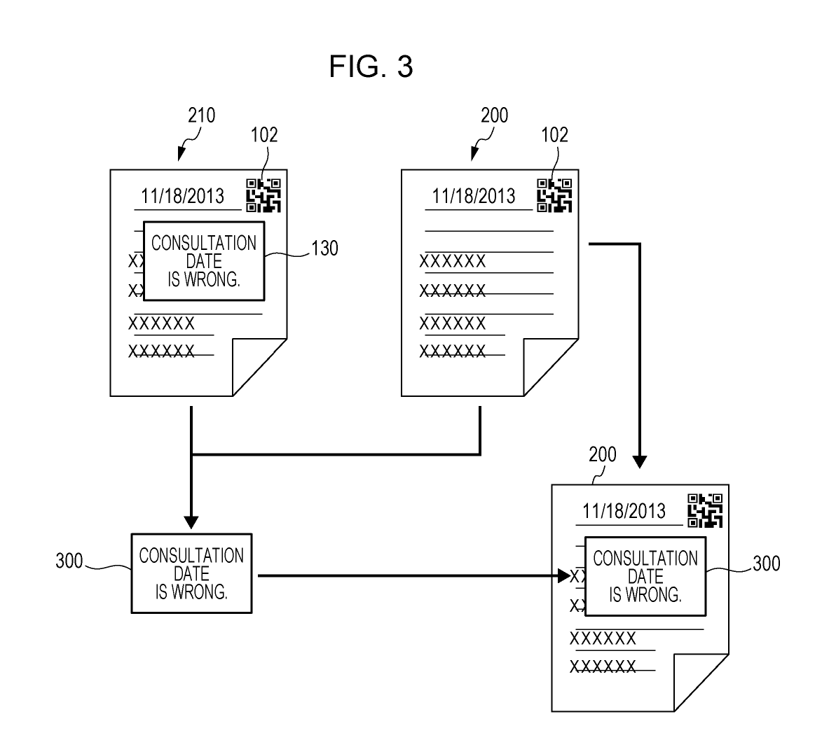

Next, operation modes related to image reading will be described with reference to FIGS. 2 and 3. In the exemplary embodiments, “correction mode” and “correction-indicating mode” exist as operation modes. In “correction mode”, new registration of image data generated by the image reading unit 12, or replacement of already-registered image data (updating of image data) is performed. In “correction-indicating mode”, difference processing by the difference processing unit 18 is performed, and difference image data is registered. A mode for performing new registration of image data may be provided separately from the correction mode as a new-registration mode.

For example, in “correction mode”, when the image of the paper original 100 illustrated in FIG. 2 is read by the image reading unit 12, the image data 200 representing the paper original 100 is generated. The controller 22 decodes the two-dimensional barcode 102 represented in the image data 200 to generate decoded information indicating information such as the type of the paper original 100, page number, patient name, patient ID, clinical department name, consultation date, the storage location of image data, and the file name of image data. Then, on the basis of the decoded information, the controller 22 assigns a file name to the image data 200, and stores the image data 200 into a preset storage location. The controller 22 may cause the image storing unit 14 to store the image data 200, or may transmit the image data 200 to the server 50 via the transmitter/receiver 24 and the network N, and cause the server 50 to store the image data 200. For example, in the image storing unit 14 or the server 50, a folder is created for each patient, and the image data 200 is stored into the folder. Alternatively, a folder may be created for each clinical department or consultation date, and image data may be stored into the folder. In a case where image data with the same file name as that of the image data to be stored is not stored in the image storing unit 14 or the server 50, the controller 22 causes the image storing unit 14 or the server 50 to store generated image data. This process corresponds to new registration. In a case where image data with the same file name as that of the image data to be stored is already stored in the image storing unit 14 or the server 50, that is, image data with the same file name as that of the image data to be stored is already registered, the controller 22 causes the image storing unit 14 or the server 50 to store newly generated image data, instead of the already-stored image data. This process corresponds to replacement (updating) of image data.

For example, in “correction mode”, when the image of the already-corrected paper original 120 illustrated in FIG. 2 is read by the image reading unit 12, the image data 220 representing the already-corrected paper original 120 is generated. As mentioned above, the controller 22 decodes the two-dimensional barcode 102 to generate decoded information. In a case where the image data 200 representing the paper original 100 that has not been corrected yet is already registered, that is, the image data 200 with the same file name as that of the image data 220 is already registered, the controller 22 causes the image storing unit 14 or the server 50 to store the image data 220 that is newly generated, instead of the image data 200 already stored in the image storing unit 14 or the server 50. The image data is updated in this way, and the image data 220 on which the correction has been reflected is newly registered.

In “correction-indicating mode”, when the image of the to-be-corrected paper original 110 illustrated in FIG. 2 is read by the image reading unit 12, the image data 210 representing the paper original 100 on which the correction-indicating note 130 is stuck is generated. As mentioned above, the controller 22 decodes the two-dimensional barcode 102 to generate decoded information. The controller 22 searches the image storing unit 14 or the server 50 for the presence of image data that has the same file name as the file name included in the decoded information. For example, in a case where the file name of the image data 200 representing the paper original 100 that has not been corrected yet is the same as the file name of the image data 210, the controller 22 acquires the image data 200 from the image storing unit 14 or the server 50. Then, as illustrated in FIG. 3, the difference processing unit 18 detects the difference between the image data 200 representing the paper original 100 that has not been corrected yet, and the image data 210 representing the paper original 100 on which the correction-indicating note 130 is stuck, thereby generating difference image data indicating a region added to the image data 200. Because the correction-indicating note 130 is stuck on the paper original 100, by executing the difference processing, the difference processing unit 18 generates difference image data (sticky-note image data 300) representing the correction-indicating note 130. When the sticky-note image data 300 is generated in this way, the controller 22 causes the image storing unit 14 or the server 50 to store the sticky-note image data 300 while associating the sticky-note image data 300 with the image data 200 representing the paper original 100. Thus, the sticky-note image data 300 functions as an annotation to the image data 200.

By executing “correction-indicating mode” mentioned above, the sticky-note image data 300 representing the correction-indicating note 130, and the image data 200 representing the paper original 100 are stored in such a way that these pieces of image data exist separately from each other. For example, the controller 22 may cause the display of the UI unit 28 to display the sticky-note image data 300 together with the image data 200, or may cause the display of the UI unit 28 to display only the image data 200 or only the sticky-note image data 300. For example, the controller 22 may cause the display to display the sticky-note image data 300 while superimposing the sticky-note image data 300 on the image data 200. The presence of the sticky-note image data 300 makes it possible for the viewer of the image data 200 to realize that the paper original 100 represented in the image data 200 has a defect, and is to be corrected later. Further, because the image data 200 is displayed, the part of the paper original 100 covered by the correction-indicating note 130 is also displayed, which prevents viewing of that part from being hindered. For example, because the correction-indicating note 130 is represented in the image data 210 representing the to-be-corrected paper original 110, the presence of a defect in the paper original 100 may be recognized by viewing the image data 210. However, because the part of the paper original 100 covered by the correction-indicating note 130 is not displayed, viewing of that part is hindered. To the contrary, by executing “correction-indicating mode” as in the exemplary embodiments, it is recognized that the paper original 100 is to be corrected later, and viewing of the part covered by the correction-indicating note 130 is prevented from being hindered.

Next, operation (Examples 1 to 6) of the image processing apparatus 10 having the above-mentioned configuration will be described.

### Example 1

First, Example 1 will be described. In Example 1, the presence or absence of a sticky note (the correction-indicating note 130) represented in image data is automatically detected, and processing is executed in accordance with the detection result. When image data is generated by the image reading unit 12, the sticky-note detector 16 detects the presence or absence of the correction-indicating note 130 represented in the image data, and outputs the detection result to the controller 22. For example, when the image of the to-be-corrected paper original 110 illustrated in FIG. 2 is read by the image reading unit 12 and the image data 210 is generated, the sticky-note detector 16 detects the correction-indicating note 130 represented in the image data 210, and outputs a detection result indicating that the correction-indicating note 130 has been detected to the controller 22. At this time, the correction-indicating note 130 is not stuck on neither the paper original 100 nor the already-corrected paper original 120. Therefore, in a case where the image of the paper original 100 or the already-corrected paper original 120 is read by the image reading unit 12 and the image data 200 or the image data 220 is generated, the correction-indicating note 130 is not detected from the image data 200 or 220. In this case, the sticky-note detector 16 outputs a detection result indicating that the correction-indicating note 130 has not been detected to the controller 22.

The controller 22 manages the status of image data (the status of a paper original represented in the image data) on the basis of the detection result outputted from the sticky-note detector 16. For example, the controller 22 defines a state of the paper original 100 in which the correction-indicating note 130 has been detected from the corresponding image data as “Correction Needed status”, and defines a state of the paper original 100 in which the correction-indicating note 130 has not been detected from the corresponding image data as “Normal status”.

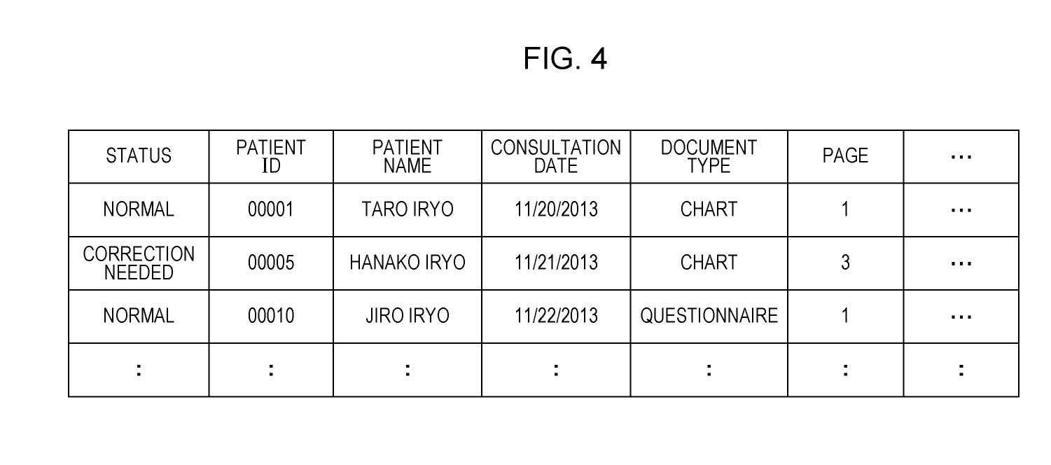

Then, on the basis of decoded information obtained from the two-dimensional barcode 102 represented in the image data 200, 210, or 220, the controller 22 manages information related to the paper original 100 (information contained in the decoded information), and status information indicating the status of the paper original 100 in association with each other. For example, as illustrated in FIG. 4, the controller 22 associates information (such as patient ID, patient name, consultation date, document type (kind), and page number) obtained from the decoded information with status information indicative of “status” of the paper original 100, and causes the image storing unit 14 or the server 50 to store those pieces of information. This processing will be described below by way of a specific example. With regard to the chart (the paper original 100) with a patent ID “00001”, the correction-indicating note 130 has not been detected from the corresponding image data, and thus the status of the chart (the paper original 100) is “Normal”. As for the chart with a patent ID “00005”, the correction-indicating note 130 has been detected from the corresponding image data, and thus the status of the chart is “Correction Needed”. The controller 22 may cause the display of the UI unit 28 to display the table illustrated in FIG. 4.

The sticky-note detector 16 detects the presence or absence of the correction-indicating note 130 each time image data is generated by the image reading unit 12, and on the basis of the detection result, the controller 22 manages the status of the image data (the status of the paper original represented in the image data). For example, even when the original status of the paper original 100 on which the same two-dimensional barcode 102 is printed is “Normal”, in a case where image reading is performed anew and the correction-indicating note 130 is detected from the resulting image data, the controller 22 changes the status of the paper original 100 represented in the image data from “Normal” to “Correction Needed”. Conversely, even when the original status is “Correction Needed”, in a case where the correction-indicating note 130 is not detected from image data that is generated anew, the controller 22 changes the status of the paper original 100 represented in the image data from “Correction Needed” to “Normal”. In this way, the controller 22 manages the status of image data (the status of the paper original) by maintaining or changing the status depending on the result of detection by the sticky-note detector 16.

As described above, the presence or absence of the correction-indicating note 130 is automatically detected, whether or not there is a need to correct the paper original 100 is determined on the basis of the detection result of the correction-indicating note 130, and the determination result is managed. As a result, the need for correcting the paper original 100 or the fact that the paper original 100 is to be corrected later may be easily checked for. For example, by displaying the table illustrated in FIG. 4, it is easily found out that the paper original 100 is to be corrected later in the subsequent workflow.

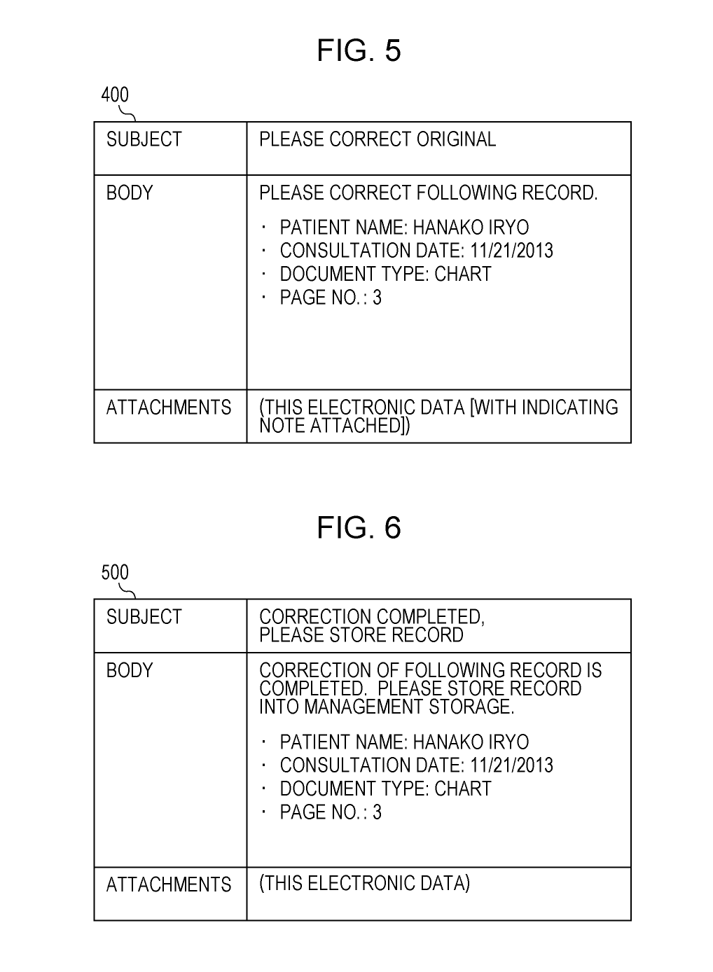

In a case where the status of the paper original 100 is “Correction Needed”, the controller 22 may transmit an e-mail indicating that a correction needs to be made, to the e-mail address or the terminal apparatus 60 of a person who has the authority to make corrections. For example, the e-mail address of a person who has the authority to make corrections is stored into the authority information storing unit 26 in advance, and the controller 22 controls the transmitter/receiver 24 to transmit, to this e-mail address, an e-mail indicating that a correction needs to be made. For example, patient information (such as patient name or patient ID), and the e-mail address of a doctor (a person having the authority to make corrections) who has conducted a consultation of the patient indicated by the patient information are stored into the authority information storing unit 26 in advance in association with each other. Then, the controller 22 acquires, from the authority information storing unit 26, an e-mail address associated with patient information acquired from the decoded information of image data that is in “Correction Needed” status, and transmits, to this e-mail address, an e-mail indicating that a correction needs to be made. For example, like an e-mail 400 illustrated in FIG. 5, the controller 22 enters “Please correct original” in the subject, and information for identifying a paper original such as “Patient Name, Consultation Date, Document Type, Page No.” in the body, and transmits the e-mail 400 to the e-mail address of a person who has the authority to make corrections. The controller 22 may transmit the image data 210 in which the correction-indicating note 130 is represented, by attaching the image data 210 to an e-mail. By sending an e-mail indicating that a correction needs to be made to a person who has the authority to make corrections, it is possible for the person having the authority to make corrections to recognize the need for correcting the paper original 100.

In a case where the status of the paper original 100 is changed from “Correction Needed” to “Normal”, the controller 22 may transmit, to the e-mail address or the terminal apparatus 60 of a person who has indicated a correction to be made (a person who has stuck the correction-indicating note 130), an e-mail indicating that the correction is completed. For example, the e-mail address of a person who has indicated a correction to be made (hereinafter also “correction-indicating person”) is stored into the authority information storing unit 26 in advance in association with the image data 200, and the controller 22 controls the transmitter/receiver 24 to transmit an e-mail indicating completion of the correction to this e-mail address. For example, like an e-mail 500 illustrated in FIG. 6, the controller 22 enters “Correction completed, please store record” in the subject, and information for identifying a paper original such as “Patient Name, Consultation Date, Document Type, Page No.” in the body, and transmits the e-mail 500 to the e-mail address of the correction-indicating person. The controller 22 may transmit the image data 220 representing the already-corrected paper original 120 by attaching the image data 220 to an email. By sending an e-mail indicating completion of correction to the correction-indicating person, it is possible for the correction-indicating person to recognize that the correction to the paper original 100 is completed.

The operation modes related to image reading may be automatically switched depending on the presence or absence of the correction-indicating note 130. For example, in a case where the correction-indicating note 130 is detected, the controller 22 sets the operation mode related to image reading to “correction-indicating mode” automatically. In this case, as illustrated in FIG. 3, the difference processing unit 18 generates the sticky-note image data 300 representing the correction-indicating note 130 by detecting the difference between the image data 200 representing the paper original 100 that has not been corrected yet and the image data 210 representing the to-be-corrected paper original 110. Then, the controller 22 causes the image storing unit 14 or the server 50 to store the sticky-note image data 300 in association with the image data 200. In this way, the sticky-note image data 300 is automatically generated and stored. In a case where multiple correction-indicating notes 130 are stuck on the paper original 100, the difference processing unit 18 may generate multiple pieces of sticky-note image data 300 representing each individual one of the multiple correction-indicating notes 130. In this case, the same number of pieces of sticky-note image data 300 as the number of correction-indicating notes 130 are generated, and stored into the image storing unit 14 or the server 50 in association with the image data 200. Alternatively, the difference processing unit 18 may generate a single piece of sticky-note image data representing multiple correction-indicating notes 130.

In a case where the correction-indicating note 130 is not detected, the controller 22 sets the operation mode related to image reading to “correction mode” automatically. In this case, the controller 22 causes the image storing unit 14 or the server 50 to store image data generated by the image reading unit 12. For example, when the already-corrected paper original 120 illustrated in FIG. 2 is read by the image reading unit 12, the image data 220 representing the already-corrected paper original 120 is generated. Because the correction-indicating note 130 is not represented in the image data 220, the correction-indicating note 130 is not detected. In this case, the controller 22 causes the image storing unit 14 or the server 50 to store the image data 220. In a case where the image data 200 representing the paper original 100 that has not been corrected yet is stored in the image storing unit 14 or the server 50, the controller 22 causes the image storing unit 14 or the server 50 to store the image data 220, instead of the image data 200. In this way, image data is automatically registered or updated.

The controller 22 may set the authority for access to image data whose status (status of the paper original) is “Correction Needed”, so that viewing of the image data is permitted only to persons permitted to access the image data, and other persons are prohibited from viewing the image data. For example, access to image data whose status is “Correction Needed” is permitted to persons having the authority to correct the paper original, persons having the authority to indicate corrections, persons having the authority to delete image data, and persons having the authority to register image data. In this case, access authority information for identifying these persons (for example, name, job category, and ID) is stored into the authority information storing unit 26 in advance. Then, upon receiving an input of identification information (for example, name, job category, and ID) of a person requesting for viewing of image data from the operating section of the UI unit 28, the controller 22 compares the identification information against the access authority information to determine whether or not to permit access. At this time, the paper original represented in the image data whose status is “Correction Needed” has a defect, and this paper original is to be corrected later. Accordingly, by restricting access to this image data, unwanted access to the image data representing the defective paper original is prevented.

The controller 22 may restrict execution of the operation mode depending on whether the user who executes reading of the image of the paper original (hereinafter also “read-executing person”) has the authority to make corrections. For example, correction authority information (for example, name, job category, and ID) for identifying persons having the authority to correct the paper original is stored into the authority information storing unit 26 in advance. Then, upon receiving an input of identification information (for example, name, job category, and ID) of a read-executing person from the operating section of the UI unit 28, the controller 22 compares the identification information against the correction authority information to determine whether or not the read-executing person has the authority to make corrections. In a case where the read-executing person has the authority to make corrections, as described above, the controller 22 executes “correction-indicating mode” or “correction mode” depending on the detection result of the correction-indicating note 130. In a case where the read-executing person does not have the authority to make corrections, if the correction-indicating note 130 is detected, the controller 22 sets the operation mode to “correction-indicating mode”, and if the correction-indicating note 130 is not detected, the controller 22 prohibits execution of “correction mode”, and stops a registration process of image data.

### Example 2

Next, Example 2 will be described. In Example 2, the presence or absence of a sticky note (the correction-indicating note 130) represented in image data is automatically detected, and processing is executed in accordance with the detection result.

When the image of a paper original is read by the image reading unit 12 and image data is newly generated, the sticky-note detector 16 detects the presence or absence of the correction-indicating note 130 represented in the image data, and outputs the detection result to the controller 22. For example, when the image of the to-be-corrected paper original 110 illustrated in FIG. 2 is read by the image reading unit 12 and the image data 210 is generated, the sticky-note detector 16 detects the correction-indicating note 130 represented in the image data 210, and outputs a detection result indicating that the correction-indicating note 130 has been detected to the controller 22. At this time, the correction-indicating note 130 is not stuck on neither the paper original 100 nor the already-corrected paper original 120. Therefore, in a case where the image of the paper original 100 or the already-corrected paper original 120 is read by the image reading unit 12, and the image data 200 or the image data 220 is generated, the correction-indicating note 130 is not detected from the image data 200 or 220. In this case, the sticky-note detector 16 outputs a detection result indicating that the correction-indicating note 130 has not been detected to the controller 22.

The corrected-part detector 20 detects the difference between image data newly generated by reading the image of the paper original by the image reading unit 12, and image data having the same file name as the above-mentioned image data and representing a paper original that has not been corrected yet. Then, the corrected-part detector 20 detects the presence or absence of a part where a difference occurs between the two pieces of image data, other than the part of the correction-indicating note 130, as a corrected part. For example, suppose that the image of the paper original 100 illustrated in FIG. 2 has been read by the image reading unit 12 in the past to generate the image data 200, and the image data 200 has been stored into the image storing unit 14 or the server 50 in advance. When, thereafter, the contents of the paper original 100 are corrected, and the image of the already-corrected paper original 120 is read by the image reading unit 12 to generate the image data 220, the corrected-part detector 20 detects the difference between the image data 200 and the image data 220 which have the same file name, and detects the presence or absence of a part (for example, the corrected part 140) where a difference occurs, other than the part of the correction-indicating note 130. In a case where the corrected part 140 is detected, the corrected-part detector 20 outputs a detection result indicating that the corrected part 140 has been detected to the controller 22. In a case where the corrected part 140 is not detected, the corrected-part detector 20 outputs a detection result indicating that the corrected part 140 has not been detected to the controller 22.

The controller 22 executes processing according to the detection result of the correction-indicating note 130 and the detection result of the corrected part 140. Hereinafter, processing executed according to these detection results will be described.

<Case Where Both the Correction-Indicating Note 130 and the Corrected Part 140 are Detected>

In a case where, with respect to image data newly generated by reading the image of a paper original by the image reading unit 12, the correction-indicating note 130 is detected, and the corrected part 140 is detected, that is, in a case where both the correction-indicating note 130 and the corrected part 140 are detected from a single piece of image data, the controller 22 causes the display of the UI unit 28 to display, as a warning, information indicating that it has been forgotten to peel off the correction-indicating note 130. The fact that the corrected part 140 is detected means that the paper original has been already corrected. The fact that the correction-indicating note 130 is detected even through the paper original has been already corrected means that it may have been forgotten to peel off the correction-indicating note 130. Accordingly, the controller 22 issues a warning that it has been forgotten to peel off the correction-indicating note 130. This allows the user to recognize if it has been forgotten to peel off the correction-indicating note 130. Even in a case where the correction-indicating note 130 is detected, if the corrected part 140 is further detected, the controller 22 stops execution of “correction-indicating mode”. Then, when the image of the already-corrected paper original 120 is read in a state in which the correction-indicating note 130 has been peeled off, the controller 22 sets the operation mode to “correction mode”. In this case, the controller 22 causes the image storing unit 14 or the server 50 to store the image data 220 representing the already-corrected paper original 120, instead of the image data 200 indicating the paper original 100 that has not been corrected yet. In this way, a warning is given to indicate that it has been forgotten to peel off the correction-indicating note 130, and a registration process of image data is stopped, thereby preventing registration of image data representing the already-corrected paper original 120 on which the correction-indicating note 130 is stuck.

<Case Where the Correction-Indicating Note 130 is Detected, and the Corrected Part 140 is Not Detected>

In a case where, with respect to image data newly generated by reading the image of a paper original by the image reading unit 12, the correction-indicating note 130 is detected, and the corrected part 140 is not detected, that is, in a case where the correction-indicating note 130 is detected but the corrected part 140 is not detected from a single piece of image data, the controller 22 sets the operation mode to “correction-indicating mode”. In this case, as illustrated in FIG. 3, the difference processing unit 18 detects the difference between past image data (for example, the image data 200 representing the paper original 100 that has not been corrected yet), and the newly generated image data (for example, the image data 210 representing the to-be-corrected paper original 110) to generate the sticky-note image data 300. Then, the controller 22 causes the image storing unit 14 or the server 50 to store the sticky-note image data 300 in association with the image data 200. When the correction-indicating note 130 is detected without the corrected part 140 being detected, this indicates that a correction has not been made, as in the case of the to-be-corrected paper original 110 illustrated in FIG. 2. Accordingly, “correction-indicating mode” is executed to generate the sticky-note image data 300 in which the correction-indicating note 130 is represented.

<Case Where the Correction-Indicating Note 130 is Not Detected, and the Corrected Part 140 is Detected>

In a case where, with respect to image data newly generated by reading the image of a paper original by the image reading unit 12, the correction-indicating note 130 is not detected, and the corrected part 140 is detected, that is, in a case where the correction-indicating note 130 is not detected but the corrected part 140 is detected from a single piece of image data, the controller 22 sets the operation mode to “correction mode”. In this case, as illustrated in FIG. 2, the controller 22 causes the image storing unit 14 or the server 50 to store the image data 220 representing the already-corrected paper original 120, instead of the image data 200 representing the paper original 100 that has not been corrected yet. When the corrected part 140 is detected without the correction-indicating note 130 being detected, this means that a correction has been already made. Accordingly, by executing “correction mode”, the image data 220 is stored into the image storing unit 14 or the server 50 instead of the image data 200, thereby updating the image data.

<Case Where Neither the Correction-Indicating Note 130 nor the Corrected Part 140 is Detected>

In a case where, with respect to image data newly generated by reading the image of a paper original by the image reading unit 12, the correction-indicating note 130 is not detected, and the corrected part 140 is not detected either, that is, in a case where neither the correction-indicating note 130 nor the corrected part 140 is detected from a single piece of image data, the controller 22 causes the image storing unit 14 or the server 50 to store the newly generated image data. In a case where past image data having the same file name as the newly generated image data is stored in the image storing unit 14 or the server 50, and the sticky-note image data 300 is not associated with this past image data unlike in the case illustrated in FIG. 3, the controller 22 causes the image storing unit 14 or the server 50 to store the newly generated image data, instead of the past image data. This process corresponds to re-digitization of a paper original.

In a case where the sticky-note image data 300 is associated with past image data, the controller 22 causes the display of the UI unit 28 to display, as a warning, information indicating that the correction-indicating note 130 has come off and the paper original has not been corrected. The fact that the sticky-note image data 300 is associated with past image data (for example, the image data 200 representing the paper original 100 that has not been corrected yet) means that the paper original 100 is to be corrected later. The fact that, despite this being the case, neither the correction-indicating note 130 nor the corrected part 140 is detected with respect to the newly generated image data means that the correction-indicating note 130 may have come off even through no correction has been made. In this case, by giving a warning to indicate that the correction-indicating note 130 has come off and the paper original has not been corrected, the status of the paper original may be recognized by the user. Further, the controller 22 stops a registration process of image data.

### Example 3

Next, Example 3 will be described. In Example 3, processing is executed in accordance with the difference between the number of correction-indicating notes 130 stuck on the to-be-corrected paper original 110, and the number of corrected parts 140 of the already-corrected paper original 120.

This processing will be described below with reference to FIG. 2. In Example 3, it is assumed that the image of the paper original 100 that has not been corrected yet is read, and the image data 200 representing the paper original 100 is stored into the image storing unit 14 in advance. Further, it is assumed that the image of the to-be-corrected paper original 110 is read, the sticky-note image data 300 is generated by the difference processing unit 18, and the sticky-note image data 300 is associated with the image data 200 in advance. In a case where multiple correction-indicating notes 130 are stuck on the paper original 100, multiple pieces of sticky-note image data 300 representing each individual one of the multiple correction-indicating notes 130 are generated by the difference processing unit 18, and the image data 200 is associated with the multiple pieces of sticky-note image data 300.

When the image of the already-corrected paper original 120 is read and the image data 220 is generated, the corrected-part detector 20 detects the difference between the image data 200 representing the paper original 100 that has not been corrected yet and the image data 220, thereby detecting the number of corrected parts 140 represented in the image data 220. For example, the corrected-part detector 20 divides the portion of the difference between the image data 200 and the image data 220 into rectangles of a preset size, and detects the number of the rectangles as the number of corrected parts 140. The corrected-part detector 20 may detect the number of correction seals placed on the already-corrected paper original 120 as the number of corrected parts.

Further, as the number of correction-indicating notes 130, the controller 22 counts the number of pieces of sticky-note image data 300 associated with the image data 200 representing the paper original 100 that has not been corrected yet. The sticky-note detector 16 may detect the number of correction-indicating notes 130 represented in the image data 210 representing the to-be-corrected paper original 110. For example, the sticky-note detector 16 detects, as a region corresponding to a single correction-indicating note 130, a region in the image data 210 which matches a preset characteristic feature, and detects the number of regions each corresponding to a single correction-indicating note 130. In this case, the sticky-note detector 16 associates information indicating the number of correction-indicating notes 130 with the image data 200 representing the paper original 100 that has not been corrected yet.

Then, the controller 22 compares the number of correction-indicating notes 130 with the number of corrected parts 140, and executes processing according to the comparison result.

In a case where the number of correction-indicating notes 130 matches the number of corrected parts 140, the controller 22 sets the operation mode to “correction mode”, and the controller 22 causes the image storing unit 14 or the server 50 to store the image data 220 representing the already-corrected paper original 120, instead of the image data 200 representing the paper original 100 that has not been corrected yet. In a case where the number of correction-indicating notes 130 matches the number of corrected parts 140, there is a possibility that the same number of corrections as the number of correction-indicating notes 130 have been made, and thus corrections have been made as indicated. Accordingly, “correction mode” is executed to update the image data 200 to the image data 220.

In a case where the number of correction-indicating notes 130 does not match the number of corrected parts 140, the controller 22 causes the display of the UI unit 28 to display a confirmation screen, which indicates that the two numbers do not match and is used to make the user select the operation mode (the correction mode, the correction-indicating mode, or Stop). Then, the controller 22 executes “correction mode” in a case where “correction mode” is selected by the user, the controller 22 executes “correction-indicating mode” in a case where “correction-indicating mode” is selected by the user, and the controller 22 stops reading of an image in a case where “Stop” is selected by the user.

As described above, in a case where the number of correction-indicating notes 130 does not match the number of corrected parts 140, the original may not have been corrected as indicated by the correction-indicating notes 130. Accordingly, by displaying the confirmation screen, erroneous corrections to the original are prevented or reduced.

### Example 4

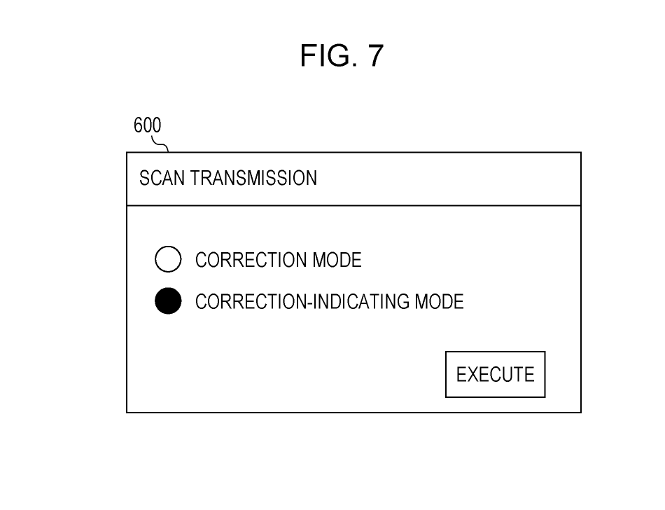

Next, Example 4 will be described. In Example 4, the user selects the operation mode. When reading an image, for example, as illustrated in FIG. 7, the controller 22 causes the display of the UI unit 28 to display a selection screen 600 for selecting the operation mode (the correction mode or correction-indicating mode) used for image reading. When the user selects “correction mode” on the selection screen 600, the controller 22 sets the operation mode to “correction mode”, and when the user selects “correction-indicating mode” on the selection screen 600, the controller 22 sets the operation mode to “correction-indicating mode”. Then, when an “Execute” button is depressed by the user, the image processing apparatus 10 reads the image of a paper original to generate image data, and executes the operation mode (the correction mode or correction-indicating mode) selected by the user. At this time, “scan transmission” illustrated in FIG. 7 is a mode for transmitting image data generated by the image reading unit 12 to an external apparatus such as the server 50 or the terminal apparatus 60. This scan transmission mode is only an example. Alternatively, image data generated by the image reading unit 12 may be stored into the image storing unit 14 without being transmitted to an external apparatus.

Further, as described above with reference to FIGS. 2 and 4 in Example 1, the controller 22 may manage information related to the paper original 100 (such as patient ID), and status information indicating the status of the paper original 100 in association with each other, on the basis of decoded information obtained from the two-dimensional barcode 102 represented in the image data 200, 210, or 220. In Example 4, the status of a paper original from which an image has been read with “correction mode” being selected by the user is defined as “Normal status”, and the status of a paper original from which an image is read with “correction-indicating mode” being selected by the user is defined as “Correction Needed status”. Referring to FIG. 4, for example, when the image of a chart (the paper original 100) with a patent ID “00001” is read in “correction mode”, the controller 22 sets the status of this chart to “Normal”. When the image of the same chart with a patient ID “00001” is read in “correction-indicating mode”, the controller 22 changes the status of this chart from “Normal” to “Correction Needed”. Further, when the image of the same chart with a patient ID “00001” is read in “correction mode”, the controller 22 changes the status of this chart from “Correction Needed” to “Normal”. In this way, the controller 22 manages the status of the paper original by maintaining or changing the status in accordance with the operation mode selected by the user.

Further, as in Example 1, in a case where the status of the paper original 100 is “Correction Needed”, the controller 22 may transmit an e-mail indicating that a correction needs to be made to the e-mail address or the terminal apparatus 60 of a person who has the authority to make corrections. In a case where the status of the paper original 100 is changed from “Correction Needed” to “Normal”, the controller 22 may transmit, to the e-mail address or the terminal apparatus 60 of a person who has indicated a correction to be made (a person who has stuck the correction-indicating note 130), an e-mail address indicating completion of the correction.

As in Example 1, the controller 22 may set the authority for access to image data whose status (status of the paper original) is “Correction Needed”, so that viewing of the image data is permitted only to persons permitted to access the image data and other persons are prohibited from viewing the image data.

The controller 22 may automatically switch operation modes depending on whether the user who executes reading of the image of a paper original (read-executing person) has the authority to make corrections. The controller 22 receives an input of identification information (for example, name, job category, and ID) of the read-executing person from the operating section of the UI unit 28, and compares the identification information with correction authority information stored in the authority information storing unit 26 to thereby determine whether or not the read-executing person has the authority to make corrections. In a case where the read-executing person has the authority to make corrections, the controller 22 sets the operation mode to “correction mode”, and in a case where the read-executing person does not have the authority to make corrections, the controller 22 sets the operation mode to “correction-indicating mode”. By switching operation modes depending on whether or not the read-executing person has the authority to make corrections in this way, image data is prevented from being replaced (updated) by a read-executing person who does not have the authority to make corrections. Further, automatically switching operation modes in this way saves the trouble of specifying the operation mode.

In a case where the read-executing person has the authority to make corrections, the controller 22 may permit selection of a mode from “correction mode” and “correction-indicating mode”, and in a case where the read-executing person does not have the authority to make corrections, the controller 22 may permit selection of “correction-indicating mode” and prohibit selection of “correction mode”. This prevents image data from being replaced by a read-executing person who does not have the authority to make corrections.

### Example 5

Next, Example 5 will be described. In Example 5, as in Example 4, the user selects the operation mode. Further, as in Example 2, the presence or absence of the correction-indicating note 130 and the presence or absence of the corrected part 140 represented in image data are automatically detected, and processing is executed in accordance with the results of these detections.

In Example 5, the following processing is executed in a case where “correction mode” is selected by the read-executing person. First, when the image of a paper original is read by the image reading unit 12 and image data is newly generated, as in Example 2, the sticky-note detector 16 detects the presence or absence of the correction-indicating note 130 represented in the image data, and outputs the detection result to the controller 22. Further, the corrected-part detector 20 detects the difference between the image data newly generated by the image reading unit 12, and image data having the same file name as the above-mentioned image data and representing a paper original that has not been corrected yet. Then, the corrected-part detector 20 detects the presence or absence of a part where a difference occurs between the two pieces of image data, other than the part of the correction-indicating note 130, as the corrected part 140, and outputs the detection result to the controller 22.

The controller 22 executes processing according to the detection result of the correction-indicating note 130 and the detection result of the corrected part 140. Hereinafter, processing executed according to these detection results will be described.

<Case Where Both the Correction-Indicating Note 130 and the Corrected Part 140 are Detected>

In a case where, with respect to image data newly generated by reading the image of a paper original by the image reading unit 12, both the correction-indicating note 130 and the corrected part 140 are detected, that is, in a case where both the correction-indicating note 130 and the corrected part 140 are detected from a single piece of image data, because the paper original has been already corrected, the controller 22 causes the display of the UI unit 28 to display, as a warning, information indicating that it has been forgotten to peel off the correction-indicating note 130. Further, the controller 22 stops execution of “correction mode” selected by the read-executing person, and stops a registration process of image data. Then, when “correction mode” is selected by the read-executing person, and the image of the already-corrected paper original 120 is read in a state in which the correction-indicating note 130 has been peeled off, the controller 22 causes the image storing unit 14 or the server 50 to store the image data 220 representing the already-corrected paper original 120, instead of the image data 200 representing the paper original 100 that has not been corrected yet. In this way, a warning is given to indicate that it has been forgotten to peel off the correction-indicating note 130, and a registration process of image data is stopped. This prevents registration of image data representing the already-corrected paper original 120 on which the correction-indicating note 130 is stuck, even in a case where “correction mode” is selected by the read-executing person.

<Case Where the Correction-Indicating Note 130 is Detected, and the Corrected Part 140 is Not Detected>

In a case where, with respect to image data newly generated by reading the image of a paper original by the image reading unit 12, the correction-indicating note 130 is detected, and the corrected part 140 is not detected, that is, in a case where the correction-indicating note 130 is detected but the corrected part 140 is not detected from a single piece of image data, the controller 22 causes the display of the UI unit 28 to display, as a warning, information indicating that the operation mode selected by the read-executing person is wrong. Further, the controller 22 stops execution of “correction mode”. The fact that “correction mode” is selected by the read-executing person normally means that the contents of the paper original 100 have been corrected and thus the already-corrected paper original 120 becomes subject to image reading. The fact that, despite this being the case, the correction-indicating note 130 is detected, and the corrected part 140 is not detected means that the contents of the paper original 100 have not been corrected, and that the correction-indicating note 130 is stuck on the paper original 100. Therefore, there is a possibility that, although “correction-indicating mode” for generating sticky-note image data representing the correction-indicating note 130 would be normally selected in such a case, “correction mode” has been selected by mistake. Accordingly, by displaying a warning indicating that the operation mode is wrong, the image of the paper original 100 that has not been corrected is prevented from being read in “correction mode”, thereby preventing the image data from being erroneously updated. Then, when “correction-indicating mode” is selected by the read-executing person, “correction-indicating mode” is executed, and sticky-note image data representing the correction-indicating note 130 is generated. At this time, the controller 22 may be configured to execute “correction mode” in a case where the read-executing person instructs “correction mode” to be executed even through a warning indicating the operation mode is wrong has been displayed.

<Case Where the Correction-Indicating Note 130 is Not Detected, and the Corrected Part 140 is Detected>

In a case where, with respect to image data newly generated by reading the image of a paper original by the image reading unit 12, the correction-indicating note 130 is not detected, and the corrected part 140 is detected, that is, in a case where the correction-indicating note 130 is not detected but the corrected part 140 is detected from a single piece of image data, the controller 22 executes “correction mode” selected by the read-executing person. In this case, the controller 22 does not cause a warning to be displayed. The fact that the correction-indicating note 130 is not detected, and the corrected part 140 is detected indicates the possibility that the paper original 100 has been corrected as indicated by the correction-indicating note 130, or that the paper original 100 has been corrected without the presence of the correction-indicating note 130. Therefore, the controller 22 executes “correction mode” without issuing a warning.

<Case Where Neither the Correction-Indicating Note 130 nor the Corrected Part 140 is Detected>

In a case where, with respect to image data newly generated by reading the image of a paper original by the image reading unit 12, neither the correction-indicating note 130 nor the corrected part 140 is detected, that is, in a case where neither the correction-indicating note 130 nor the corrected part 140 is detected from a single piece of image data, the controller 22 causes the image storing unit 14 or the server 50 to store the newly generated image data. In a case where past image data having the same file name as the newly generated image data is stored in the image storing unit 14 or the server 50, and the sticky-note image data 300 is not associated with this past image data unlike in the case illustrated in FIG. 3, the controller 22 causes the image storing unit 14 or the server 50 to store the newly generated image data, instead of the past image data. This process corresponds to re-digitization of a paper original.

In a case where the sticky-note image data 300 representing the correction-indicating note 130 is associated with past image data, this indicates the possibility that the correction-indicating note 130 has come off and the contents of the paper original have not been corrected. Accordingly, the controller 22 causes the display of the UI unit 28 to display information to that effect as a warning. Further, the controller 22 stops execution of “correction mode”, and stops a registration process of image data. Then, when the contents of the paper original are corrected, and “correction mode” is selected by the read-executing person, the controller 22 executes “correction mode”. At this time, the controller 22 may be configured to execute “correction mode” in a case where the read-executing person instructs “correction mode” to be executed even through the warning is displayed.

### Example 6

Next, Example 6 will be described. In Example 6, as in Example 4, the user selects the operation mode. Further, as in Example 3, processing is executed in accordance with the difference between the number of correction-indicating notes 130 stuck on the to-be-corrected paper original 110, and the number of corrected parts 140 of the already-corrected paper original 120.

In Example 6, in a case where “correction mode” is selected by the read-executing person, as in Example 4, the number of correction-indicating notes 130 and the number of corrected parts 140 are detected, and processing is executed in accordance with whether or not the two numbers match.

In a case where the number of correction-indicating notes 130 and the number of corrected parts 140 match, the controller 22 sets the operation mode to “correction mode” as selected by the read-executing person, and the controller 22 causes the image storing unit 14 or the server 50 to store the image data 220 representing the already-corrected paper original 120, instead of the image data 200 representing the paper original 100 that has not been corrected yet. In a case where the number of correction-indicating notes 130 and the number of corrected parts 140 do not match, the controller 22 causes the display of the UI unit 28 to display a confirmation screen, which indicates that the two numbers do not match and is used to make the user select the operation mode (the correction mode, the correction-indicating mode, or Stop). Then, the controller 22 executes the operation mode selected by the user. In Example 6, as in Example 4, by displaying the confirmation screen, erroneous corrections to the original are prevented or reduced.

### Comparative Example 1

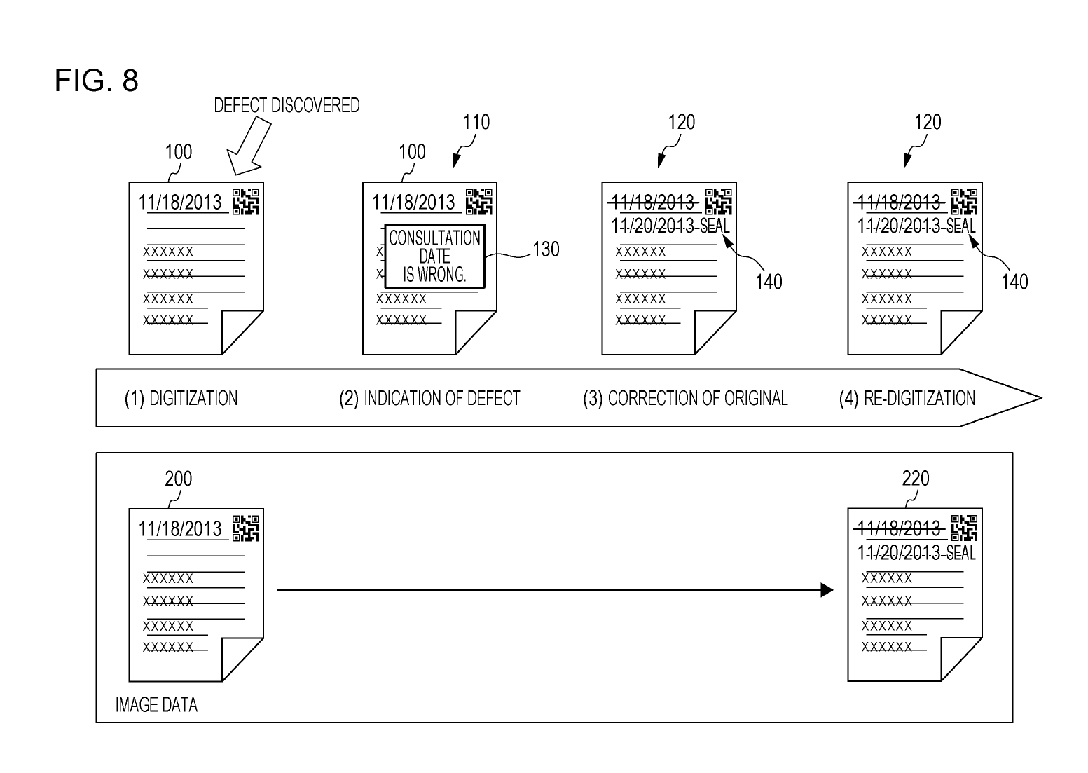

Next, Comparative Example 1 for comparison with the exemplary embodiments will be described with reference to FIG. 8. In Comparative Example 1, digitization of the paper original 100 is implemented along the flow of the following processes: (1) digitization of the paper original 100; (2) indication of a defect in the contents of the paper original 100; (3) correction of the paper original 100; and (4) digitization of the already-corrected paper original 120 (re-digitization of the paper original). First, in the digitization of the paper original 100 in the process (1), the image of the paper original 100 is read to generate the image data 200 representing the paper original 100. The image data 200 is stored into an apparatus such as a server, for example. Thereafter, in the process (2), a defect in the contents of the paper original 100 is indicated and the correction-indicating note 130 is stuck onto the paper original 100, by a person who has the authority to audit/check charts or the like such as a health information manager. Then, in the process (3), the contents of the paper original 100 are corrected by a person who has the authority to make corrections such as a doctor, thereby creating the already-corrected paper original 120 in which the corrected part 140 is included. Thereafter, in the process (4), the image of the already-corrected paper original 120 is read, and the image data 220 representing the already-corrected paper original 120 is generated. The image data 220 is stored into an apparatus such as a server, instead of the image data 200 representing the paper original 100 that has not been corrected yet. When the contents of the paper original 100 are corrected in this way, image data is updated. According to the above-mentioned implementation, until re-digitization of the paper original takes place in the process (4) after a defect in the contents of the paper original 100 is indicated, indication of the defect in the contents or the correction to be made is not reflected on the image data. Therefore, until re-digitization of the paper original takes place in the process (4), even when a viewer looks at the image data, the user is unable to recognize that the contents of the paper original 100 have a defect, or that a correction is to be made later. To the contrary, according to the exemplary embodiments, at the point when a defect in the contents of the paper original 100 is indicated in the process (2), that is, at the point when the correction-indicating note 130 is stuck onto the paper original 100, the image of the to-be-corrected paper original 110 is read to generate sticky-note image data representing the correction-indicating note 130, and the sticky-note image data is stored in association with the image data 200 representing the paper original 100. Accordingly, by viewing the image data 200, it is possible to recognize that the contents of the paper original 100 have a defect, or that a correction is to be made later. In this way, in the exemplary embodiments, a defect in the contents of the paper original 100 may be reflected on image data at an earlier time in comparison to Comparative Example 1. This allows a third person to recognize that a defect exists in the contents or that a correction is to be made later, thereby preventing viewing or distribution (such as downloading or printing) of erroneous information.

### Comparative Example 2

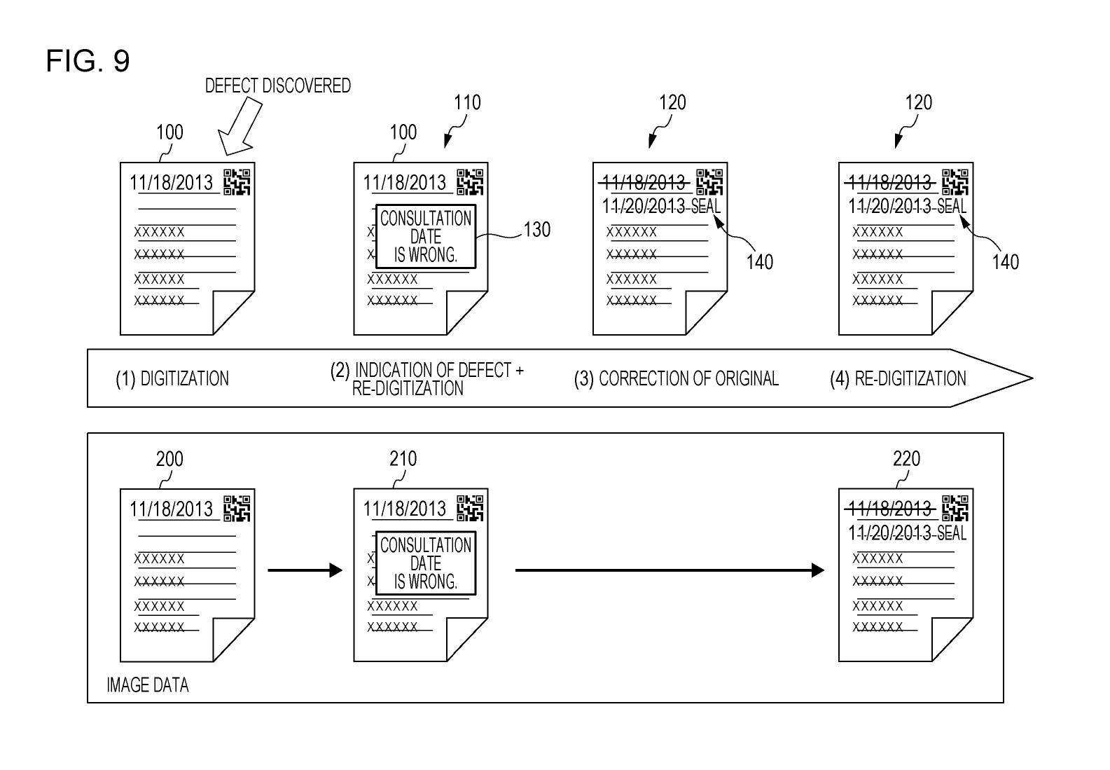

Next, Comparative Example 2 for comparison with the exemplary embodiments will be described with reference to FIG. 9. In Comparative Example 2, digitization of the paper original 100 is implemented along the flow of the following processes: (1) digitization of the paper original 100; (2) indication of a defect in the contents of the paper original 100, and digitization of the to-be-corrected paper original 110 (re-digitization of the paper original); (3) correction of the paper original 100; and (4) digitization of the already-corrected paper original 120 (re-digitization of the paper original). First, in the digitization of the paper original 100 in the process (1), the image of the paper original 100 is read to generate the image data 200 representing the paper original 100. The image data 200 is stored into an apparatus such as a server, for example. Thereafter, in the process (2), a defect in the contents of the paper original 100 is indicated and the correction-indicating note 130 is stuck onto the paper original 100, by a person who has the authority to audit/check charts or the like such as a health information manager. The image of the to-be-corrected paper original 110 on which the correction-indicating note 130 is stuck is read at this point, thereby generating the image data 210 representing the to-be-corrected paper original 110. The correction-indicating note 130 is represented in the image data 210. The image data 210 is stored into an apparatus such as a server, instead of the image data 200 representing the paper original 100. Then, in the process (3), the contents of the paper original 100 are corrected by a person who has the authority to make corrections such as a doctor, thereby creating the already-corrected paper original 120 in which the corrected part 140 is included. Thereafter, in the process (4), the image of the already-corrected paper original 120 is read, and the image data 220 representing the already-corrected paper original 120 is generated. The image data 220 is stored into an apparatus such as a server, instead of the image data 200 representing the paper original 100 that has not been corrected yet. In this way, in Comparative Example 2, when a defect in the contents of the paper original 100 is indicated, the image data 210 is saved instead of the image data 200, and further, when the contents of the paper original 100 are corrected, the image data 220 is saved instead of the image data 210. According to the above-mentioned implementation, by viewing the image data 210 in which the correction-indicating note 130 is represented, it is possible to recognize that the contents of the paper original 100 have a defect, or that a correction is to be made later. However, the part of the paper original 100 covered by the correction-indicating note 130 is not represented in the image data 210. Therefore, even if the image data 210 is viewed, the portion of the paper original 100 covered by the correction-indicating note 130 is not viewed. To the contrary, in the exemplary embodiments, sticky-note image data representing the correction-indicating note 130 is generated by detecting the difference between the image data 200 and the image data 210, and the sticky-note image data is stored in association with the image data 200 representing the paper original 100 that has not been corrected yet. Because the sticky-note image data representing the correction-indicating note 130, and the image data 200 representing the paper original 100 are generated and stored in this way, it is possible for the viewer to recognize that the contents of the paper original 100 have a defect, or that a correction is to be made later, without compromising the viewability of the paper original 100.

The image processing apparatus 10 described above is realized by, for example, cooperation of hardware resources and software. Specifically, the image processing apparatus 10 includes a processor such as a CPU (not illustrated). As the processor reads and executes a program stored in a memory (not illustrated), the respective functions of the sticky-note detector 16, the difference processing unit 18, the corrected-part detector 20, and the controller 22 are realized. The above-mentioned program is stored into the memory via a storage medium such as a CD or a DVD, or a communication path such as a network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a detector that detects presence or absence of a sticky note stuck on an original on a basis of first image data, the first image data being generated by reading an image of the original; and
an executing unit that executes processing related to correction of the original, in a case where the sticky note is detected by the detector.

2. The image processing apparatus according to claim 1, wherein:
in a case where the sticky note is detected by the detector, the executing unit associates correction-needed-status information with information related to the original and manages the correction-needed-status information, the correction-needed-status information indicating that the original is to be corrected later; and
in a case where the sticky note is not detected by the detector, the executing unit associates normal-status information with information related to the original and manages the normal-status information, the normal-status information indicating that the original is not to be corrected later.

3. The image processing apparatus according to claim 2, wherein in a case where the sticky note is detected by the detector, the executing unit further transmits information indicating an instruction that a correction is to be made, to a terminal apparatus of a user who has an authority to correct the original.

4. The image processing apparatus according to claim 2, wherein in a case where, after the correction-needed-status information is associated with the information related to the original and managed, an image of the original is read again and the sticky note is not detected by the detector, the executing unit further transmits information indicating that the original has been already corrected, to a terminal apparatus of a user who has stuck the sticky note onto the original.

5. The image processing apparatus according to claim 2, wherein the executing unit further restricts access to the first image data representing the original with which the correction-needed-status information is associated, to a specific user.

6. The image processing apparatus according to claim 1, further comprising a memory that stores second image data, the second image data being generated by reading an image of the original that has not been corrected yet and on which the sticky note is not stuck, wherein:
the executing unit further executes a first process in a case where the sticky note is detected by the detector, the first process including detecting a difference between the first image data from which the sticky note is detected and the second image data to generate sticky-note image data representing the sticky note, and causing the memory to store the sticky-note image data in association with the second image data; and
the executing unit further executes a second process in a case where the sticky note is not detected by the detector, the second process including causing the memory to store the first image data from which the sticky note is not detected, instead of the second image data.

7. The image processing apparatus according to claim 6, wherein the executing unit further prohibits execution of the second process, in a case where a user who has instructed the first image data to be read has no authority to correct the original.

8. The image processing apparatus according to claim 6, wherein in a case where the first process is executed as a result of the sticky note being detected from the first image data by the detector, and the sticky-note image data is stored into the memory in association with the second image data:
the detector receives third image data, and detects a difference between the third image data and the second image data to further detect a number of corrected parts of the original, the third image data being generated by reading an image of the original that has been already corrected and on which the sticky note is not stuck; and
in a case where a number of the sticky notes detected from the first image data and the number of the corrected parts detected match, the executing unit causes the memory to store the third image data instead of the second image data, and in a case where the number of the sticky notes detected from the first image data and the number of the corrected parts detected do not match, the executing unit outputs information indicating that the number of the sticky notes and the number of the corrected parts do not match.

9. The image processing apparatus according to claim 1, further comprising a memory that stores second image data, the second image data being generated by reading an image of the original that has not been corrected yet and on which the sticky note is not stuck, wherein:
the detector detects presence or absence of the sticky note stuck on the original on a basis of the first image data, and detects a difference between the second image data and the first image data to detect whether or not the original has been corrected; and
the executing unit gives a warning related to correction of the original, or executes registration of image data related to the original, depending on whether or not the sticky note exists and whether or not the original has been corrected.

10. The image processing apparatus according to claim 9, wherein in a case where the sticky note is detected by the detector, and a correction to the original is detected, the executing unit outputs information indicating that it has been forgotten to peel off the sticky note.

11. The image processing apparatus according to claim 9, wherein in a case where the sticky note is detected by the detector, and a correction to the original is not detected, the executing unit detects a difference between the first image data from which the sticky note is detected and the second image data to generate sticky-note image data representing the sticky note, and causes the memory to store the sticky-note image data in association with the second image data.

12. The image processing apparatus according to claim 9, wherein in a case where the sticky note is not detected by the detector, and a correction to the original is detected, the executing unit causes the memory to store the first image data from which the sticky note is not detected, instead of the second image data.

13. The image processing apparatus according to claim 9, wherein in a case where the sticky note is not detected by the detector and a correction to the original is not detected, and sticky-note image data representing the sticky note is associated with the second image data, the executing unit outputs information indicating that the sticky note has come off and the original has not been corrected.

14. A non-transitory computer readable medium storing a program causing a computer to execute a process, the process comprising:
detecting presence or absence of a sticky note stuck on an original on a basis of first image data, the first image data being generated by reading an image of the original; and executing processing related to correction of the original, in a case where the sticky note is detected by the detector.

15. An information processing method comprising:
detecting presence or absence a sticky note stuck on an original on a basis of first image data, the first image data being generated by reading an image of the original; and
executing processing related to correction of the original, in a case where the sticky note is detected by the detector.
